(19) United States
(12) Patent Application Publication
(10) Pub. No.: US 2025/0065344 A1
(43) Pub. Date: Feb. 27, 2025

(54) SPRAY NOZZLE WITH MULTIPLE DISCHARGE ORIFICES FOR PRODUCING FULL CONE SPRAY PATTERN

(71) Applicant: Spraying Systems Co., Wheaton, IL (US)

(72) Inventor: Tim Hennessy, Plainfield, IL (US)

(21) Appl. No.: 18/814,171

(22) Filed: Aug. 23, 2024

Related U.S. Application Data
(60) Provisional application No. 63/534,614, filed on Aug. 25, 2023.

(51) Int. Cl. B05B 1/06

(52) U.S. Cl. CPC B05B 1/06

(57) ABSTRACT

A spray nozzle assembly includes a body and a spray tip supported on the body. The spray tip includes a fluid inlet passage that terminates in an end wall. An annular discharge passage is arranged in the spray tip downstream of the end wall and the fluid inlet passage. The annular discharge passage defines a circular ridge in an external downstream surface of the spray tip. A plurality of discharge orifices through which fluid is discharged from the spray tip provided in the circular ridge. Each discharge orifice communicates with the annular discharge orifice and is formed in a respective notch in the circular ridge with each notch having at least one sidewall that defines a deflector surface for the respective discharge orifice.

### CROSS-REFERENCE TO RELATED APPLICATION

This patent application claims the benefit of U.S. Provisional Patent Application No. 63/534,614, filed Aug. 25, 2023, which is incorporated by reference.

### BACKGROUND OF THE INVENTION

Spray nozzle assemblies that produce a full cone-shaped discharge pattern have long been used in various industries for spraying fluids onto objects. In one common application, spray nozzle assemblies with full cone-shaped discharge patterns are used to spray fluids onto round objects on a moving conveyor. For example, such spray nozzle assemblies are frequently used in the food preparation industry to spray oil, flavorings, or other coatings onto objects such as buns, pizza crusts, pans or other similar round shaped objects. As compared to spray nozzle assemblies that produce a flat fan-shaped pattern, which produces a rectangular spray pattern on a moving conveyor, a spray nozzle assembly that produces a cone-shaped discharge pattern will result in less wasted spray leading to more efficient fluid usage.

While full-cone spray nozzle assemblies perform well in many applications in which the spray nozzle assembly is spraying continuously, problems can arise when using pulse width modulation to control the flow rate of the spray nozzle. Pulse width modulated spray nozzle assemblies use a rapidly cycling solenoid control valve to switch the flow of fluid through the spray nozzle assembly between the on and off states many times per second. The frequency and duty cycle of the valve are electronically controlled to give the required coverage and flow characteristics. The frequency is the number of on-off transitions per second, while duty cycle is the percentage of time the valve remains on over a single on-off period.

Some common full-cone spray nozzle assemblies utilize an internal vane to generate the swirl needed to create the cone pattern. Others use a core with angled slots or holes to generate the swirl. However, when using pulse width modulation with these types of full-cone spray nozzles, the cone can break down and flow control can become unpredictable. While other full-cone spray nozzle designs have a more stable cone pattern even when using pulse width modulation, such designs can still produce an uncontrolled spray or drip at the start of each spray cycle before the full cone pattern is achieved. These issues in controlling the pulse width modulated spray can lead to unsatisfactory spray coatings on at least some of the products being sprayed.

### OBJECTS OF THE INVENTION

In view of the foregoing, a general object of the present invention is to provide a spray nozzle assembly that produces a full-cone discharge pattern and can be accurately and consistently controlled using pulse width modulation.

A related object of the present invention is to provide a spray nozzle assembly that produces a stable full-cone discharge pattern throughout an entire spray cycle.

A further object of the present invention is to provide a full-cone spray nozzle assembly that has a flexible design that can be easily modified to produce different spray characteristics.

### BRIEF DESCRIPTION OF THE SEVERAL VIEWS OF THE DRAWINGS

FIG. 1A is a perspective view of an exemplary spray nozzle assembly for producing a full-cone spray pattern in accordance with the present invention.

FIG. 1B is a partially cutaway, perspective view of the spray nozzle assembly of FIG. 1A.

FIG. 2 is a perspective view of the spray tip of the spray nozzle assembly of FIG. 1A.

FIG. 3 is a side view of the spray tip of FIG. 2.

FIG. 4 is an end view of the discharge end of the spray tip of FIG. 2.

FIG. 5 is a cross-sectional view of the spray tip of FIG. 2 taken in the plane of the line 5-5 in FIG. 4.

FIG. 6 is a cross-sectional view of the spray tip of FIG. 2 taken in the plane of the line 6-6 in FIG. 4.

FIG. 7 is an end view of the upstream end of the spray tip of FIG. 2.

FIG. 8 is a side view of the spray tip of FIG. 2 showing the discharge pattern produced by the spray tip.

FIG. 9 is an end view of the discharge end of a further embodiment of a spray tip according to the present disclosure.

FIG. 10 is a cross-sectional view of the spray tip of FIG. 9 taken in the plane of line 10-10 of FIG. 9.

FIG. 11 is an end view of the discharge end of a further embodiment of a spray tip according to the present disclosure.

FIG. 12 is a cross-sectional view of the spray tip of FIG. 11 taken in the plane of line 12-12 of FIG. 11.

FIG. 13 is a detail view of an embodiment of the discharge notch of the spray tip according to the present disclosure.

FIG. 14 is a detail view of another embodiment of the discharge notch of the spray tip according to the present disclosure.

FIG. 15 is a detail view of another embodiment of the discharge notch of the spray tip according to the present disclosure.

### DETAILED DESCRIPTION OF THE INVENTION

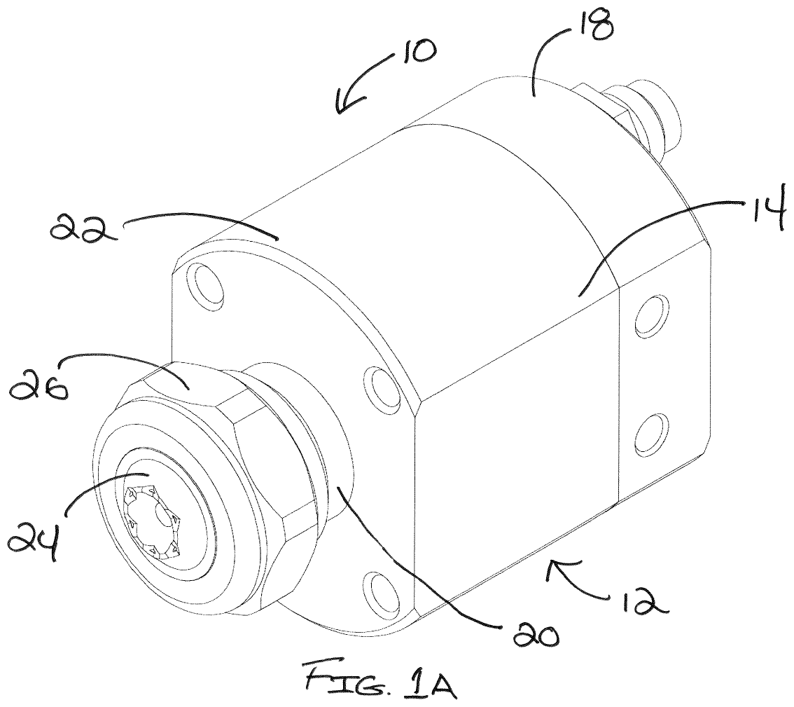

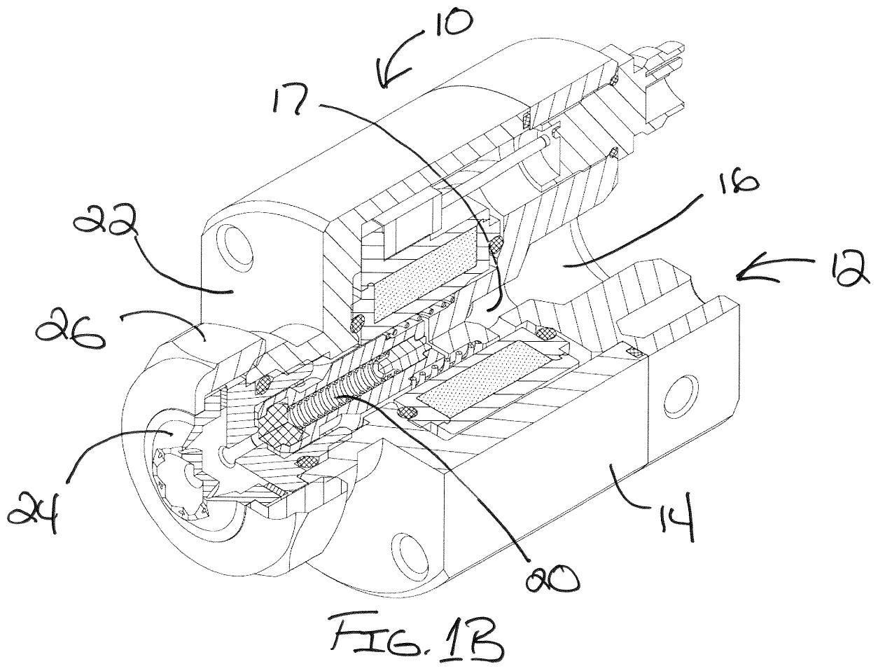

Referring now more particularly to FIGS. 1A, 1B, and 2 of the drawings, there is shown an illustrative spray nozzle assembly 10 in accordance with the present invention. As discussed further below, exemplary applications in which the illustrated spray nozzle assembly 10 has particular utility are applications in which the spray is controlled by pulse width modulation. However, it should be understood that the present invention is not limited to any particular application and instead could be used in any spraying application in which a full cone spray pattern is desired. Relatedly, it should be understood that the spray nozzle assembly 10 of the present invention is not limited to any particular spray fluid or spray target and instead may be used to discharge any suitable fluid onto any suitable target.

For producing an oscillating on/off flow condition, the illustrated spray nozzle assembly 10 is equipped with a pulse width modulation (PWM) valve assembly 12. The PWM valve assembly 12 is configured to allow the spray nozzle assembly 10 to achieve a pulsing flow that rapidly alternates between on and off flow conditions. To this end, the PWM valve assembly 12 may include a nozzle or valve body 14 which contains an electrically actuated on/off solenoid that can oscillate rapidly between an open position in which fluid is allowed to pass into the spray nozzle assembly 10 and a closed position in which the flow of fluid into the spray nozzle assembly 10 is blocked. The use of the PWM valve assembly 12 can allow the flow rate produced by the spray nozzle assembly 10 to be adjusted in a very precise manner without changing the pressure of the fluid supply simply by adjusting the on/off duty cycle of the spray nozzle assembly 10 via the PWM valve assembly 12. The PWM valve assembly 12 may be of a commercially known type such as offered by Spraying Systems Co., assignee of the present application, under the trademarks PulsaJet and DynaJet. Various components and their mode of operation of the illustrated spray nozzle assembly 10 and PWM valve assembly 12 may be similar to those described in U.S. Pat. No. 7,086,613, the disclosure of which is incorporated herein by reference. As noted above, while the present invention is particularly applicable to spray nozzle assemblies utilizing PWM flow control, it should be understood that the spray nozzle assembly configurations of the present invention are not limited to use with a PWM valve.

For connection to a supply of fluid, the valve body 14 includes a fluid inlet 16 in this case on an upstream end 18 of the valve body 14 as shown in FIG. 1B. In a known manner, the fluid inlet 16 may communicate with an internal fluid passage 17 in the valve body 14 that directs fluid to a fluid outlet 20 at a downstream end 22 of the valve body 14.

For shaping the fluid into a desired full cone spray pattern, the spray nozzle assembly 10 further includes an attached spray tip 24 through which fluid is discharged. In the illustrated embodiment, the spray tip 24 is attached to the fluid outlet 20 at the downstream end 22 of the valve body 14. As shown in FIGS. 1A and 1B, the spray tip 24 is secured to the valve body 14, in this case, by a retaining cap 26. For example, the retaining cap 26 may be internally threaded so as to engage with external threads on the fluid outlet 20 of the valve body 14. It should be understood that the present invention is not limited to any particular method for connecting the spray tip 24 the valve body 14.

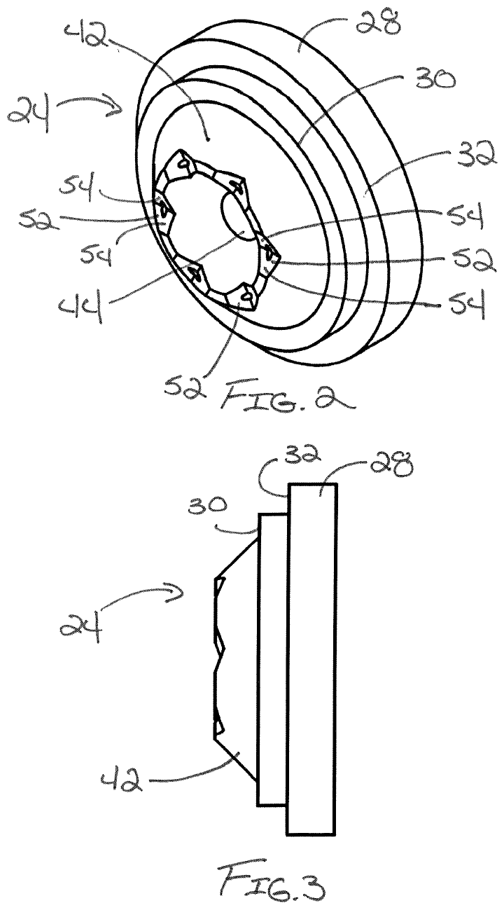

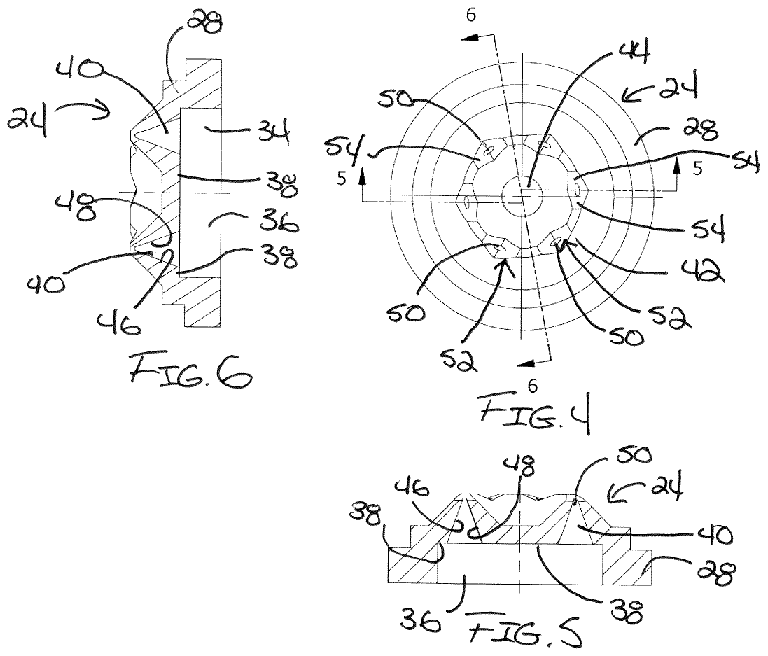

Additional details regarding the configuration and operation of the spray tip 24 can be seen from FIGS. 2-6. In this case, as shown in FIGS. 2 and 3, the spray tip 24 includes a tip body 28 having an external surface that defines first and second annular shoulders 30, 32 that facilitate securing of the spray tip 24 to the valve body 14. As shown in FIGS. 5 and 6, the spray tip 24 further includes an internal cylindrical recess 34 in the upstream end of the tip body 28 defines a fluid inlet passage 36 of the tip body 28. When the illustrated spray tip 24 is attached to the PWM valve assembly 12 (such as shown in FIGS. 1A and 1B), the internal cylindrical recess 34 of the spray tip 24 communicates with the fluid outlet 20 of the valve body 14 such that fluid exiting the PWM valve assembly 12 is directed into the fluid inlet passage 36 of the spray tip 24. As shown in FIGS. 5 and 6, the fluid inlet passage 36 terminates in an end wall 38 that is arranged at the downstream end of the internal cylindrical recess 34.

To facilitate production of a full cone spray pattern, the fluid inlet passage 36 of the spray tip 24, in turn, communicates with an annular fluid discharge passage 40 that is arranged downstream of the cylindrical recess 34 as also shown in FIGS. 5 and 6. In the illustrated embodiment, the annular fluid discharge passage 40 is in the form of an internal groove in the tip body 28 that extends downstream from the end wall 38 of the fluid inlet passage 36. The groove defining the annular discharge passage 40 is configured in this case such that the end wall 38 includes a circular portion in the center of the annular discharge passage 40 and a ring-portion radially outward of the annular discharge passage 40. When viewed from the exterior of the spray tip, as best shown in FIGS. 2 and 6, the annular discharge passage 40 of the FIGS. 2-6 embodiment defines a circular ridge 42 in the external downstream surface of the body 28 of the spray tip 24 that surrounds a center indented portion 44. Additionally, the annular discharge passage 40 of the embodiment of FIGS. 2-6 has sidewalls 46, 48 that taper inwardly or converge as they extend in the downstream direction such that the sidewalls 46, 48 produce a V-shape when viewed in cross-section as shown in FIGS. 5 and 6. As discussed further below, the annular discharge passage 40 may have different cross-sectional configurations based on the desired spray pattern characteristics.

The annular discharge passage 40, in turn, directs fluid to a plurality of discharge orifices 50 through which fluid exits the annular discharge passage 40 and the spray tip 24. The plurality of discharge orifices 50 are evenly spaced from each other about the circumference of the annular discharge passage 40 (as shown in FIG. 4) and are formed in the downstream end of the annular discharge passage 40, which in this case is where the two sidewalls 46, 48 of the annular discharge passage 40 intersect (as shown in FIG. 5). More specifically, as shown in FIG. 4, the exterior surface of the ridge 42 formed on the exterior surface of the tip body 28 by the annular discharge passage 40 is intersected by a plurality of cuts or notches 52. As shown in FIG. 5, each of these notches 52 is deep enough to produce a corresponding opening in the spray tip body 28 that communicates with the annular discharge passage 40. These openings at the bottom of the respective notches 52 define the discharge orifices 50, with the discharge orifices 50 being arranged in a circular pattern generally centered on the center indented portion 44 of the circular ridge 42 in the exterior surface of the tip body 28.

In the illustrated embodiment, as shown in FIGS. 2 and 4, each notch 52 has two opposing sidewalls 54 that intersect at their upstream end and diverge from each other as they extend in the downstream direction to form a V-shape. A cross-sectional view showing this V-shaped configuration of an individual notch 52 is provided in FIG. 13. With this configuration, for each notch 52, the discharge orifice 50 is centered on the line where the two sidewalls 54 of the notch 52 intersect with a respective half of the discharge orifice 50 being formed in each of the sidewalls 50. The opposing sidewalls 54 of the notch 52 in the exterior ridge 42 define deflection surfaces downstream of the respective discharge orifice 50 that help shape the spray pattern produced by the individual discharge orifices 50. As explained further below, the notches 52 may have different configurations depending on the desired spray pattern characteristics. Moreover, the number of notches 52, and thus the number of discharge orifices 50, may also vary depending on the desired spray pattern. For example, six notches 52 and discharge orifices 50 are shown in the embodiment of FIGS. 2-6. However, in other embodiments, the spray tip 24 may have more or fewer discharge orifices 50 as desired depending again on the desired flow rate of the spray tip 24 and the desired spray characteristics.

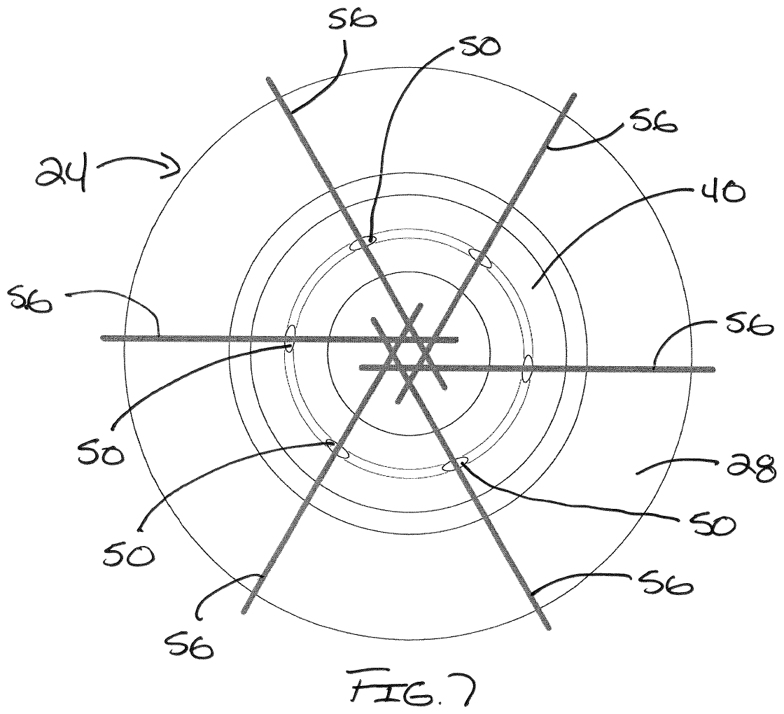

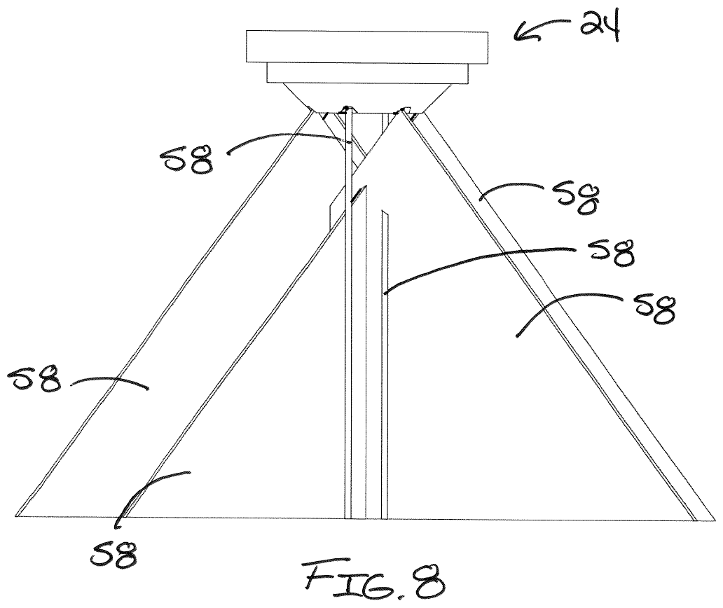

Due to its annular configuration, the discharge passage 40 channels the flow of liquid such that liquid enters from each side or end of each discharge orifice 50. This creates an impingement flow that allows each individual discharge orifice 50 to produce a flat fan spray pattern. The respective centerlines of these individual flat fan spray patterns are shown by the lines 56 in FIG. 7. These lines 56 also represent centerlines of the individual notches 52. As can be seen from the lines 56 of FIG. 7 and the individual discharge patterns 58 shown in FIG. 8, the individual flat fan spray patterns 58 intersect each other in such a way so as to form a generally flower- or star-shaped pattern that in operation is equivalent to a full-cone discharge pattern. As can be seen from FIG. 7, the centerlines 56 of the individual flat fan spray patterns are offset from the center of the annular discharge passage 40 and circular ridge 42. This offset helps avoid excessive spray collisions between the individual flat fan spray patterns 58 that could lead to an over accumulation of fluid near the center of the overall discharge pattern.

The use of the annular discharge passage 40 directing fluid to the plurality of discharge orifices 50 along the annular discharge passage 40 avoids production of the swirling flow patterns produced by other full cone spray nozzles. This allows for a full-cone discharge pattern with a crisper shut-off of flow thereby avoiding drips or undeveloped streams particularly at the start and end of spray cycles.

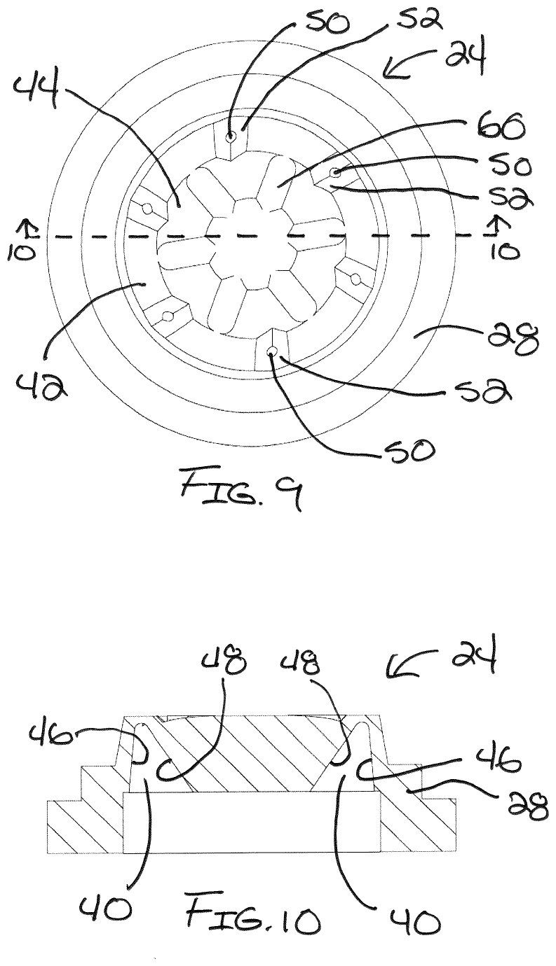

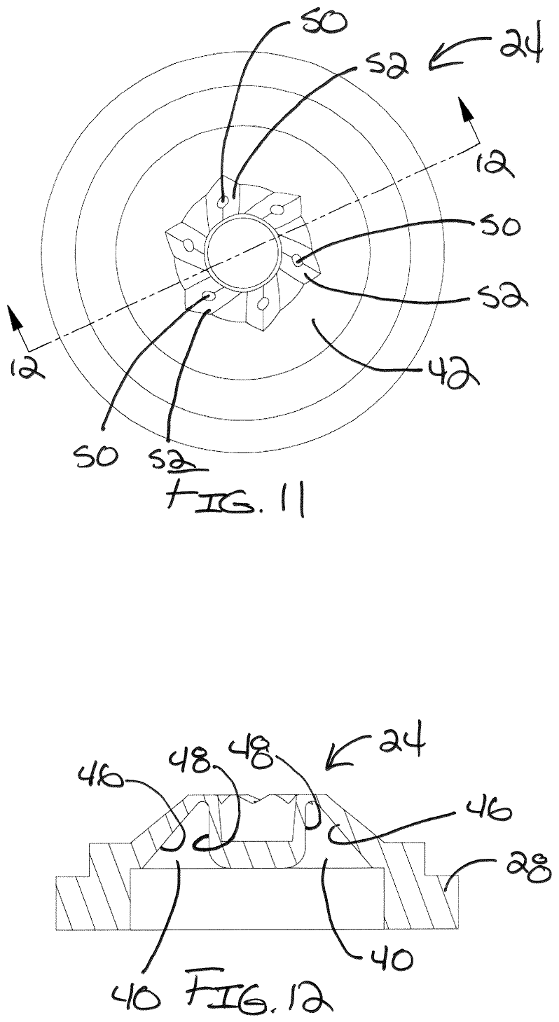

The configuration of the annular discharge passage 40 and the notches 52 forming the discharge orifices 50 may be varied to adjust the characteristics of the full cone spray pattern. For example, in the embodiment of FIGS. 2-6, the sidewalls 46, 48 of the annular discharge passage 40 are symmetrical or mirror-images of each other in that each sidewall 46, 48 tapers inwardly at the same angle as they extend in the downstream direction. However, the sidewalls 46, 48 of the annular discharge passage 40 need not be symmetrical. In the embodiment shown in FIGS. 9-10, the annular discharge passage 40 has a radially outward sidewall 46 that does not taper, but instead extends substantially straight as it extends in the downstream direction. In contrast, with the embodiment of FIGS. 11-12, the radially inward sidewall 48 of the discharge passage 40 is substantially straight. Using an annular discharge passage 40 with an asymmetrical sidewall arrangement tends to offset the spray pattern. More specifically, with the embodiment of FIGS. 9-10 (i.e. the embodiment with the straight radially outward sidewall 46), the individual flat spray patterns produced by the discharge orifices 50 tend to by directed slightly further away (as compared to the embodiment of FIGS. 2-6) from the center of the spray tip 24. Conversely, with the embodiment of FIGS. 11-12 (i.e., the embodiment with the straight radially inward sidewall 48), the individual flat fan spray patterns produced by the discharge orifices 50 tend to be directed more toward the center of the spray tip 24.

The embodiment of FIGS. 9-10 also includes a hub and spoke structure 60 in the center indented portion 44 of the circular ridge 42 on the outer surface of the spray tip body 28 (see FIG. 9). The hub and spoke structure 60 adds strength to the center portion 44 of the spray tip 24 and thus can be useful with spray tips manufactured using a 3D printing or injection molding process. However, other center structures could also be used.

The cross-sectional configuration of the notches 52 that form the discharge orifices 50 can also be varied into order to adjust the characteristics of the individual flat fan spray patterns that comprise the full cone spray pattern. For example, notches 52 with a V-shaped cross section, such as shown in FIG. 13, generally produce a flat fan pattern that is somewhat tapered spray with the majority of the liquid flow being located in the center or middle 50% of the spray pattern. With a V-shaped notch 52, the larger the angle A forming the V-shape, the narrower the spray angle produced with more flow in the center of the spray pattern as compared to notches 52 with a smaller angle A. In particular, as the angle A is reduced, the spray angle widens and more spray volume is pushed towards the ends of the spray pattern.

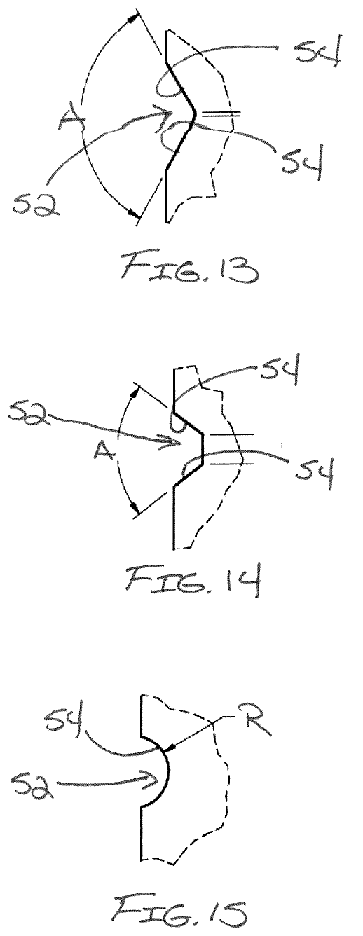

The embodiment of FIG. 15 includes a notch 52 with a U-shape having a radius R and a continuous sidewall 54 (which is equivalent to the two sidewalls 54 of the embodiments of FIGS. 13 and 14). A U-shaped notch 52 produces a more even spray pattern as compared to a V-shaped notch. As the radius R of the U-shape is reduced, the spray angle becomes wider and a lesser flow rate is achieved per notch. A notch 52 with a flat bottom such as shown in FIG. 14 has a more even spray pattern similar to the U-shaped notch of FIG. 15. The flat bottom notch of FIG. 14, can result in a larger, less obstructed discharge orifice that can resist clogging even when spraying less clean liquids that have more particulate matter. As will be appreciated, any desired configurations can be used for the annular discharge passage and notches can be used, for example, depending on the desired spray characteristics of the spray tip 24.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A spray nozzle assembly comprising:
a body having a fluid inlet and a fluid outlet with an internal fluid passage connecting the fluid inlet to the fluid outlet;
a spray tip supported on the body, the spray tip including a fluid inlet passage that communicates with the fluid outlet of the nozzle body, the fluid inlet passage terminating in an end wall at a downstream end in a direction of fluid flow from the fluid inlet passage, an annular discharge passage being arranged in the spray tip downstream of the end wall and the fluid inlet passage, the annular discharge passage defining a circular ridge in an external downstream surface of the spray tip; and
a plurality of discharge orifices through which fluid is discharged from the spray tip, the plurality of discharge orifices being provided in the circular ridge and spaced from each other about a circumference of the circular ridge; each discharge orifice communicating with the annular discharge orifice and being formed in a respective notch in the circular ridge, each notch having at least one sidewall that defines a deflector surface for the respective discharge orifice.

2. The spray nozzle assembly of claim 1, wherein the annular discharge passage has opposing, symmetric sidewalls that converge towards each other as they extend in the downstream direction to produce a V-shaped cross-section.

3. The spray nozzle assembly of claim 2, wherein each discharge orifice is formed at a location in which the opposing sidewalls of the annular discharge passage intersect.

4. The spray nozzle assembly of claim 2, wherein each discharge orifice is configured to produce a flat fan spray pattern.

5. The spray nozzle assembly of claim 4, wherein the flat fan spray pattern of each discharge orifice has a respective centerline and the centerlines of the flat fan spray patterns of the discharge orifices are offset from a center of the circular ridge.

6. The spray nozzle assembly of claim 1, wherein the annular discharge passage has opposing first and second sidewalls that are asymmetric with the first sidewall extending straight in the downstream direction and the second sidewall extending at an angle that converges toward the first sidewall as the second sidewall extends in the downstream direction.

7. The spray nozzle assembly of claim 6, wherein the first sidewall of the annular discharge passage is a radially inward side of the annular discharge passage and the second sidewall is a radially outward side of the annular discharge passage.

8. The spray nozzle assembly of claim 6, wherein the second sidewall of the annular discharge passage is a radially inward side of the annular discharge passage and the first sidewall is a radially outward side of the annular discharge passage.

9. The spray nozzle assembly of claim 1, wherein each notch includes at least two sidewalls that define a V-shaped cross-section of the notch.

10. The spray nozzle assembly of claim 1, wherein the sidewall of each notch defines a U-shaped cross-section of the notch.

11. The spray nozzle assembly of claim 1, wherein each notch has a two sidewalls that are connected by a flat bottom.

12. The spray nozzle assembly of claim 1, wherein the body includes a pulse width modulation valve assembly.

13. A spray tip for a spray nozzle assembly, the spray tip comprising:
a spray tip body including a fluid inlet passage, the fluid inlet passage terminating in an end wall at a downstream end in a direction of fluid flow from the fluid inlet passage, an annular discharge passage being arranged in the spray tip downstream of the end wall and the fluid inlet passage, the annular discharge passage defining a circular ridge in an external downstream surface of the spray tip; and
a plurality of discharge orifices through which fluid is discharged from the spray tip, the plurality of discharge orifices being provided in the circular ridge and spaced from each other about a circumference of the circular ridge; each discharge orifice communicating with the annular discharge orifice and being formed in a respective notch in the circular ridge, each notch having at least one sidewall that defines a deflector surface for the respective discharge orifice.

14. The spray tip of claim 13, wherein the annular discharge passage has opposing, symmetric sidewalls that converge towards each other as they extend in the downstream direction to produce a V-shaped cross-section.

15. The spray tip of claim 13, wherein the annular discharge passage has opposing first and second sidewalls that are asymmetric with the first sidewall extending straight in the downstream direction and the second sidewall extending at an angle that converges toward the first sidewall as the second sidewall extends in the downstream direction.

16. The spray tip of claim 15, wherein the first sidewall of the annular discharge passage is a radially inward side of the annular discharge passage and the second sidewall is a radially outward side of the annular discharge passage.

17. The spray tip of claim 15, wherein the second sidewall of the annular discharge passage is a radially inward side of the annular discharge passage and the first sidewall is a radially outward side of the annular discharge passage.

18. The spray tip of claim 13, wherein each notch includes at least two sidewalls that define a V-shaped cross-section of the notch.

19. The spray tip of claim 13, wherein the sidewall of each notch defines a U-shaped cross-section of the notch.

20. The spray tip of claim 13, wherein each notch has a two sidewalls that are connected by a flat bottom.
